(19) United States
(12) Patent Application Publication
(10) Pub. No.: US 2024/0199775 A1
(43) Pub. Date: Jun. 20, 2024

(54) METHODS AND CATALYST SYSTEMS FOR PRODUCTION OF ISOTACTIC POLYPROPYLENE

(71) Applicant: Dow Global Technologies LLC, Midland, MI (US)

(72) Inventors: Carl N. Iverson, Los Alamos, NM (US); Thomas Wesley Karjala, JR., Lake Jackson, TX (US); Yi Jin, Lake Jackson, TX (US); Michael J. Zogg, JR., Lake Jackson, TX (US)

(73) Assignee: Dow Global Technologies LLC, Midland, MI (US)

(21) Appl. No.: 18/553,266

(22) PCT Filed: Mar. 28, 2022
(86) PCT No.: PCT/US2022/022108

§ 371 Date: Sep. 29, 2023

Related U.S. Application Data
(60) Provisional application No. 63/168,603, filed on Mar. 31, 2021.

(51) Int. Cl. C08F 210/06

(52) U.S. Cl. CPC C08F 210/06

(57) ABSTRACT

Methods of propylene polymerization incorporate bis biphenyl-phenoxy procatalysts favoring polypropylene isotacticity at elevated reactor temperatures. The methods include polymerizing propylene in the presence of a catalyst system to produce a propylene-based polymer. The catalyst system includes a metal-ligand complex selected from bis-biphenyl-phenoxy procatalysts. Polymerization reactions result in polypropylenes having greater than 90% isotacticity, as measured by percentages of isotactic triads, at reaction temperatures from 110° C. to 190 ° C. or from 160 ° C. to 190 ° C.

### TECHNICAL FIELD

Embodiments of the present disclosure generally relate to methods of propylene polymerization and, more specifically, to methods for propylene polymerization incorporating bis-biphenyl-phenoxy procatalysts favoring polypropylene isotacticity even at elevated reactor temperatures.

### BACKGROUND

Propylene-based polymers such as polypropylene are produced via various catalyst systems. the selection of which may be an important factor contributing to the characteristics and properties of the polymers. Among the many characteristics of interest for polypropylenes is isotacticity. As is well understood, polypropylene has a repeat unit (—CH₂C*H(CH₃)—) that includes a chiral carbon atom (C*) with a pendant methyl group attached. In perfectly isotactic polypropylene, all of the chiral carbon atoms in the polymer backbone have the same chirality. In perfectly syndiotactic polypropylene, the chirality of this carbon atom alternates with each successive repeat unit. In atactic polypropylene, the chirality of this carbon atom is random through the polymer chain.

Propylene isotacticity may be quantified by various analytical techniques. One such technique is the quantification of isotactic triads by NMR, which assesses for every three neighboring monomer units (triads) along the full polypropylene chain what percent of the triads (% mm) have three isotactic monomers, relative to the total number of triads in the polymer chain. Syndiotactitcity may be assessed in a similar manner by quantifying what percent of the triads (% rr) are syndiotactic, relative to the total number of triads in the polymer chain.

In polypropylene production as with many chemical processes, it is understood that by increasing polymerization reactor temperatures, reactor throughput may be increased and advantages to reactor efficiency may be obtained. Yet, many catalyst systems applicable to propylene polymerization typically decrease in efficiency and may lose the capability to produce high levels of polymer isotacticity (as measured by % mm triads, for example) as reactor temperature is increased, particularly to greater than 130° C.

Accordingly, there remain ongoing needs for propylene polymerization processes and catalyst systems that exhibit suitable catalyst activity and polymer molecular weight characteristics, even at elevated reactor temperatures, without significant loss of isotacticity in the resulting polypropylenes.

### SUMMARY

Against the foregoing background, example embodiments disclosed herein are directed to propylene polymerization processes that include polymerizing propylene in the presence of a catalyst system to produce a propylene-based polymer, the catalyst system comprising a metal-ligand complex according to formula (I):

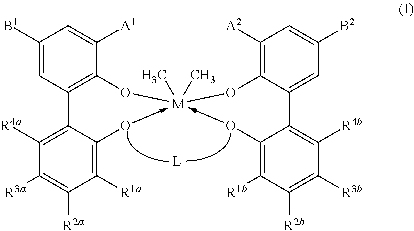

In formula (I), M is zirconium or hafnium; A¹ and A² are independently selected from the group consisting of 3,5-disubstituted phenyl radicals having formula (I-a) as described subsequently herein and disubstituted carbazolyl radicals having formula (I-b) as described subsequently herein; B¹ and B² are independently (C₁-C₄₀)hydrocarbyl; R^{1a}, R^{1b}, R^{2a}, R^{2b}, R^{3a}, R^{3b} are R^{4a}, and R^{4b} independently selected from —H, (C₁-C₄₀)hydrocarbyl. (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen; L is selected from the group consisting of —(CH₂)₂—, —(CH₂)₃—, —(CH₂)₄—, —(CH(CH₃)CH₂CH(CH₃))—, —(CH₂CH(R^{C})CH₂)—, —CH₂Si(R^{C})₂CH₂—, and —CH₂Ge(R^{C})₂CH₂—; and each R^{C}, R^{P}, and R^{N} in formula (I) is independently (C₁-C₃₀)hydrocarbyl. (C₁-C₃₀)heterohydrocarbyl, or —H.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### DETAILED DESCRIPTION

Specific embodiments of propylene polymerization methods and associated catalyst systems will now be described. It should be understood that the polymerization methods and associated catalyst systems of this disclosure may be embodied in different forms and should not be construed as limited to the specific embodiments set forth in this disclosure. Rather, embodiments are provided so that this disclosure will be thorough and complete, and will fully convey the scope of the subject matter to those skilled in the art.

Common abbreviations are listed below:

Me: methyl; Et: ethyl; Ph: phenyl; Bn: benzyl; i-Pr: iso-propyl (1-methylethyl); t-Bu: tert-butyl (1.1-dimethylethyl); t-Oct: tert-octyl (1,1,3,3-tetramethylbutyl); THF: tetrahydrofuran; Et₂O: diethyl ether; CH₂Cl₂: dichloromethane; C₆D₆: deuterated benzene or benzene-d6: CDCl₃: deuterated chloroform; Na₂SO₄: sodium sulfate; MgSO₄: magnesium sulfate; HCl: hydrogen chloride; n-BuLi: butyllithium; HfCl₄: hafnium(IV) chloride; HfBn₄: hafnium(IV) tetrabenzyl; ZrCl₄: zirconium(IV) chloride; ZrBn₄: zirconium(IV) tetrabenzyl; ZrBn₂Cl₂(OEt₂): zirconium (IV) dibenzyl dichloride mono-diethyletherate; HfBn₂Cl₂(OEt₂): hafnium (IV) dibenzyl dichloride mono-diethyletherate; N_{2:} nitrogen gas; PhMe: toluene; PPR: parallel polymerization reactor; MAO: methylaluminoxane; MMAO: modified methylaluminoxane; NMR: nuclear magnetic resonance; mmol: millimoles; mL: milliliters; M: molar; min or mins: minutes; h or hrs: hours; d: days; rpm: revolutions per minute; STP: standard pressure and temperature.

The term “independently selected” is used herein with respect to variable groups to indicate that the variable groups may be identical or different, without regard to the identity of any other variable group. A chemical name associated with a variable group is intended to convey the chemical structure that is recognized in the art as corresponding to that of the chemical name. Thus, chemical names are intended to supplement and illustrate, not preclude, the structural definitions known to those of skill in the art.

The term “procatalyst” refers to a compound that has catalytic activity when combined with an activator. The term “activator” refers to a compound that chemically reacts with a procatalyst in a manner that converts the procatalyst to a catalytically active catalyst. As used herein, the terms “co-catalyst” and “activator” are interchangeable terms.

When used to describe certain carbon atom-containing chemical groups, a parenthetical expression having the form “(Cₓ-C_{y})” means that the unsubstituted form of the chemical group has from x carbon atoms to y carbon atoms, inclusive of x and y. For example, a (C₁-C₅₀)alkyl is an alkyl group having from 1 to 50 carbon atoms in its unsubstituted form. In some embodiments and general structures, certain chemical groups may be substituted by one or more substituents such as R^{S}. An R^{S} substituted chemical group defined using the “(Cₓ-C_{y})” parenthetical may contain more than y carbon atoms depending on the identity of any groups R^{S}. For example, a “(C₁-C₅₀)alkyl substituted with exactly one group R^{S}, where R^{S} is phenyl (—C₆H₅)” may contain from 7 to 56 carbon atoms. Thus, in general when a chemical group defined using the “(Cₓ-C_{y})” parenthetical is substituted by one or more carbon atom-containing substituents R^{S}, the minimum and maximum total number of carbon atoms of the chemical group is determined by adding to both x and y the combined sum of the number of carbon atoms from all of the carbon atom-containing substituents R^{S}.

The term “substitution” means that at least one hydrogen atom (—H) bonded to a carbon atom or heteroatom of a corresponding unsubstituted compound or functional group is replaced by a substituent (e.g. R^{S}). The term “persubstitution” means that every hydrogen atom (H) bonded to a carbon atom or heteroatom of a corresponding unsubstituted compound or functional group is replaced by a substituent (e.g., R^{S}). The term “polysubstitution” means that at least two, but fewer than all, hydrogen atoms bonded to carbon atoms or heteroatoms of a corresponding unsubstituted compound or functional group are replaced by a substituent.

The term “—H” means a hydrogen or hydrogen radical that is covalently bonded to another atom. “Hydrogen” and “—H” are interchangeable, and unless clearly specified have identical meanings.

The term “(C₁-C₅₀)hydrocarbyl” means a hydrocarbon radical of from 1 to 50 carbon atoms and the term “(C₁-C₅₀)hydrocarbylene” means a hydrocarbon diradical of from 1 to 50 carbon atoms, in which each hydrocarbon radical and each hydrocarbon diradical is aromatic or non-aromatic, saturated or unsaturated, straight chain or branched chain, cyclic (having three carbons or more, and including mono- and poly-cyclic, fused and non-fused polycyclic, and bicyclic) or acyclic, and substituted by one or more R^{S} or unsubstituted.

In this disclosure, a (C₁-C₅₀)hydrocarbyl may be an unsubstituted or substituted (C₁-C₅₀)alkyl, (C₃-C₅₀)cycloalkyl, (C₃-C₂₀)cycloalkyl-(C₁-C₂₀)alkylene, (C₆-C₄₀)aryl, or (C₆-C₂₀)aryl-(C₁-C₂₀)alkylene (such as benzyl (—CH₂-C₆H₅)).

The terms “(C₁-C₅₀)alkyl” and “(C₁-C₁₈)alkyl” mean a saturated straight or branched hydrocarbon radical of from 1 to 50 carbon atoms and a saturated straight or branched hydrocarbon radical of from 1 to 18 carbon atoms, respectively, that is unsubstituted or substituted by one or more R^{S}. Examples of unsubstituted (C₁-C₅₀)alkyl are unsubstituted (C₁-C₂₀)alkyl; unsubstituted (C₁-C₁₀)alkyl; unsubstituted (C₁-C₅)alkyl; methyl; ethyl; 1-propyl; 2-propyl; 1-butyl; 2-butyl; 2-methylpropyl; 1,1-dimethylethyl; 1-pentyl; 1-hexyl; 1-heptyl; 1-nonyl; and 1-decyl. Examples of substituted (C₁-C₄₀)alkyl are substituted (C₁-C₂₀)alkyl, substituted (C₁-C₁₀)alkyl, trifluoromethyl, and [C₄₅]alkyl. The term “[C₄₅]alkyl” means there is a maximum of 45 carbon atoms in the radical, including substituents, and is, for example, a (C₂₇-C₄₀)alkyl substituted by one R^{S}, which is a (C₁-C₅)alkyl, respectively. Each (C₁-C₅)alkyl may be methyl, trifluoromethyl, ethyl, 1-propyl, 1-methylethyl, or 1,1-dimethylethyl.

The term “(C₆-C₅₀)aryl” means an unsubstituted or substituted (by one or more R^{S}) mono-, bi- or tricyclic aromatic hydrocarbon radical of from 6 to 40 carbon atoms, of which at least from 6 to 14 of the carbon atoms are aromatic ring carbon atoms. A monocyclic aromatic hydrocarbon radical includes one aromatic ring; a bicyclic aromatic hydrocarbon radical has two rings; and a tricyclic aromatic hydrocarbon radical has three rings. When the bicyclic or tricyclic aromatic hydrocarbon radical is present, at least one of the rings of the radical is aromatic. The other ring or rings of the aromatic radical may be independently fused or non-fused and aromatic or non-aromatic. Examples of unsubstituted (C₆-C₅₀)aryl include: unsubstituted (C₆-C₂₀)aryl, unsubstituted (C₆-C₁₈)aryl; 2-(C₁-C₅)alkyl-phenyl; phenyl; fluorenyl; tetrahydrofluorenyl; indacenyl; hexahydroindacenyl; indenyl; dihydroindenyl; naphthyl; tetrahydronaphthyl; and phenanthrene. Examples of substituted (C₆-C₄₀)aryl include: substituted (C₁-C₂₀)aryl; substituted (C₆-C₁₈)aryl; 2,4-bis([C₂₀]alkyl)-phenyl; polyfluorophenyl; pentafluorophenyl; and fluoren-9-one-1-yl.

The term “(C₃-C₅₀)cycloalkyl” means a saturated cyclic hydrocarbon radical of from 3 to 50 carbon atoms that is unsubstituted or substituted by one or more R^{S}. Other cycloalkyl groups (e.g., (Cₓ-C_{y})cycloalkyl) are defined in an analogous manner as having from x to y carbon atoms and being either unsubstituted or substituted with one or more R^{S}. Examples of unsubstituted (C₃-C₄₀)cycloalkyl are unsubstituted (C₃-C₂₀)cycloalkyl, unsubstituted (C₃-C₁₀)cycloalkyl. cyclopropyl, cyclobutyl, cyclopentyl, cyclohexyl, cycloheptyl, cyclooctyl, cyclononyl, and cyclodecyl. Examples of substituted (C₃-C₄₀)cycloalkyl are substituted (C₃-C₂₀)cycloalkyl, substituted (C₃-C₁₀)cycloalkyl, cyclopentanon-2-yl, and 1-fluorocyclohexyl.

Examples of (C₁-C₅₀)hydrocarbylene include unsubstituted or substituted (C₆-C₅₀)arylene, (C₃-C₅₀)cycloalkylene, and (C₁-C₅₀)alkylene (e.g., (C₁-C₂₀)alkylene). The diradicals may be on the same carbon atom (e.g., —CH₂—) or on adjacent carbon atoms (i.e., 1,2-diradicals), or are spaced apart by one, two, or more than two intervening carbon atoms (e.g., 1,3-diradicals, 1,4-diradicals, etc.). Some diradicals include 1,2-, 1,3-, 1,4-, or an α, ω-diradical, and others a 1,2-diradical. The α,ω-diradical is a diradical that has maximum carbon backbone spacing between the radical carbons. Some examples of (C₂-C₂₀)alkylene α,ω-diradicals include ethan-1,2-diyl (i.e. —CH₂CH₂—), propan-1,3-diyl (i.e. —CH₂CH₂CH₂—), 2-methylpropan-1,3-diyl (i.e. —CH₂CH(CH₃)CH₂—). Some examples of (C₆-C₅₀)arylene α,ω-diradicals include phenyl-1,4-diyl, napthalen-2,6-diyl, or napthalen-3,7-diyl.

The term “(C₁-C₅₀)alkylene” means a saturated straight chain or branched chain diradical (i.e., the radicals are not on ring atoms) of from 1 to 50 carbon atoms that is unsubstituted or substituted by one or more R^{S}. Examples of unsubstituted (C₁-C₅₀)alkylene are unsubstituted (C₁-C₂₀)alkylene, including unsubstituted —CH₂CH₂—, —(CH₂)₃—, —(CH₂)₄—, —(CH₂)₅—, —(CH₂)₆—, —(CH₂)₇—, —(CH₂)₈—, —CH₂C*HCH₃, and —(CH₂)₄C*(H)(CH₃), in which “C*” denotes a carbon atom from which a hydrogen atom is removed to form a secondary or tertiary alkyl radical. Examples of substituted (C₁-C₅₀)alkylene are substituted (C₁-C₂₀)alkylene, —CF₂—, —C(O)—, and —(CH₂)₁₄C(CH₃)₂(CH₂)₅— (i.e., a 6,6-dimethyl substituted normal-1,20-eicosylene). Since as mentioned previously two R^{S} may be taken together to form a (C₁-C₁₈)alkylene, examples of substituted (C₁-C₅₀)alkylene also include 1,2-bis(methylene)cyclopentane, 1,2-bis(methylene)cyclohexane, 2,3-bis(methylene)-7,7-dimethyl-bicyclo[2.2.1]heptane, and 2,3-bis (methylene)bicyclo [2.2.2] octane.

The term “(C₃-C₅₀)cycloalkylene” means a cyclic diradical (i.e., the radicals are on ring atoms) of from 3 to 50 carbon atoms that is unsubstituted or substituted by one or more R^{S}.

The term “heteroatom,” refers to an atom other than hydrogen or carbon. Examples of groups containing one or more than one heteroatom include O, S, S(O), S(O)₂, Si(R^{C})₂, P(R^{P}) N(R^{N}), —N═C(R^{C})₂, —Ge(R^{C})₂—, or —Si(R^{C})—, where each R^{C} and each R^{P} is unsubstituted (C₁-C₁₈)hydrocarbyl or —H, and where each R^{N} is unsubstituted (C₁-C₁₈)hydrocarbyl. The term “heterohydrocarbon” refers to a molecule or molecular framework in which one or more carbon atoms of a hydrocarbon are replaced with a heteroatom. The term “(C₁-C₅₀)heterohydrocarbyl” means a heterohydrocarbon radical of from 1 to 50 carbon atoms, and the term “(C₁-C₅₀)heterohydrocarbylene” means a heterohydrocarbon diradical of from 1 to 50 carbon atoms. The heterohydrocarbon of the (C₁-C₅₀)heterohydrocarbyl or the (C₁-C₅₀)heterohydrocarbylene has one or more heteroatoms. The radical of the heterohydrocarbyl may be on a carbon atom or a heteroatom. The two radicals of the heterohydrocarbylene may be on a single carbon atom or on a single heteroatom. Additionally, one of the two radicals of the diradical may be on a carbon atom and the other radical may be on a different carbon atom; one of the two radicals may be on a carbon atom and the other on a heteroatom; or one of the two radicals may be on a heteroatom and the other radical on a different heteroatom. Each (C₁-C₅₀)heterohydrocarbyl and (C₁-C₅₀)heterohydrocarbylene may be unsubstituted or substituted (by one or more R^{S}), aromatic or non-aromatic, saturated or unsaturated, straight chain or branched chain, cyclic (including mono- and poly-cyclic, fused and non-fused polycyclic), or acyclic.

The (C₁-C₅₀)heterohydrocarbyl may be unsubstituted or substituted. Non-limiting examples of the (C₁-C₅₀)heterohydrocarbyl include (C₁-C₅₀)heteroalkyl, (C₁-C₅₀)hydrocarbyl-O—, (C₁-C₅₀)hydrocarbyl-S—, (C₁-C₅₀)hydrocarbyl-S(O)—, (C₁-C₅₀)hydrocarbyl-S(O)₂—, (C₁-C₅₀)hydrocarbyl-Si(R^{C})₂—, (C₁-C₅₀)hydrocarbyl-N(R^{N})—, (C₁-C₅₀)hydrocarbyl-P(R^{P})—, (C₂-C₅₀)heterocycloalkyl, (C₂-C₁₉)heterocycloalkyl-(C₁-C₂₀)alkylene, (C₃-C₂₀)cycloalkyl-(C₁-C₁₉)heteroalkylene, (C₂-C₁₉)heterocycloalkyl-(C₁-C₂₀)heteroalkylene, (C₁-C₅₀)heteroaryl, (C₁-C₁₉)heteroaryl-(C₁-C₂₀)alkylene, (C₆-C₂₀)aryl-(C₁-C₁₉)heteroalkylene, or (C₁-C₁₉)heteroaryl-(C₁-C₂₀)heteroalkylene.

The term “(C₄-C₅₀)heteroaryl” means an unsubstituted or substituted (by one or more R^{S}) mono-, bi-, or tricyclic heteroaromatic hydrocarbon radical of from 4 to 50 total carbon atoms and from 1 to 10 heteroatoms. A monocyclic heteroaromatic hydrocarbon radical includes one heteroaromatic ring; a bicyclic heteroaromatic hydrocarbon radical has two rings; and a tricyclic heteroaromatic hydrocarbon radical has three rings. When the bicyclic or tricyclic heteroaromatic hydrocarbon radical is present, at least one of the rings in the radical is heteroaromatic. The other ring or rings of the heteroaromatic radical may be independently fused or non-fused and aromatic or non-aromatic. Other heteroaryl groups (e.g., (Cₓ-C_{y})heteroaryl generally. such as (C₄-C₁₂)heteroaryl) are defined in an analogous manner as having from x to y carbon atoms (such as 4 to 12 carbon atoms) and being unsubstituted or substituted by one or more than one R^{S}. The monocyclic heteroaromatic hydrocarbon radical is a 5-membered ring or a 6-membered ring. The 5-membered ring monocyclic heteroaromatic hydrocarbon radical has 5 minus h carbon atoms. where h is the number of heteroatoms and may be 1, 2, or 3; and each heteroatom may be O, S, N, or P.

Examples of 5-membered ring heteroaromatic hydrocarbon radicals include pyrrol-1-yl; pyrrol-2-yl; furan-3-yl; thiophen-2-yl; pyrazol-1-yl; isoxazol-2-yl; isothiazol-5-yl; imidazol-2-yl; oxazol-4-yl; thiazol-2-yl; 1,2,4-triazol-1-yl; 1,3,4-oxadiazol-2-yl; 1,3,4-thiadiazol-2-yl; tetrazol-1-yl; tetrazol-2-yl; and tetrazol-5-yl. The 6-membered ring monocyclic heteroaromatic hydrocarbon radical has 6 minus h carbon atoms, where h is the number of heteroatoms and may be 1 or 2 and the heteroatoms may be N or P.

Examples of 6-membered ring heteroaromatic hydrocarbon radicals include pyridine-2-yl; pyrimidin-2-yl; and pyrazin-2-yl. The bicyclic heteroaromatic hydrocarbon radical can be a fused 5,6- or 6,6-ring system. Examples of the fused 5,6-ring system bicyclic heteroaromatic hydrocarbon radical are indol-1-yl; and benzimidazole-1-yl. Examples of the fused 6,6-ring system bicyclic heteroaromatic hydrocarbon radical are quinolin-2-yl; and isoquinolin-1-yl. The tricyclic heteroaromatic hydrocarbon radical can be a fused 5,6,5-; 5,6,6-; 6,5,6-; or 6,6,6-ring system. An example of the fused 5,6,5-ring system is 1,7-dihydropyrrolo[3,2-f]indol-1-yl. An example of the fused 5.6.6-ring system is 1H-benzo[f] indol-1-yl. An example of the fused 6,5,6-ring system is 9H-carbazol-9-yl. An example of the fused 6,5,6-ring system is 9H-carbazol-9-yl. An example of the fused 6,6,6-ring system is acrydin-9-yl.

The term “(C₁-C₅₀)heteroalkyl” means a saturated straight or branched chain radical containing one to fifty carbon atoms and one or more heteroatom. The term “(C₁-C₅₀)heteroalkylene” means a saturated straight or branched chain diradical containing from 1 to 50 carbon atoms and one or more than one heteroatoms. The heteroatoms of the heteroalkyls or the heteroalkylenes may include Si(R^{C})³, Ge(R^{C})₃, Si(R^{C})₂, Ge(R^{C})₂, P(R^{P})₂, P(R^{P}), N(R^{N})₂, N(R^{N}), N, O, OR^{C}, S, SR^{C}, S(O), and S(O)₂, wherein each of the heteroalkyl and heteroalkylene groups are unsubstituted or are substituted by one or more R^{S}.

Examples of unsubstituted (C₂-C₄₀)heterocycloalkyl include unsubstituted (C₂-C₂₀)heterocycloalkyl, unsubstituted (C₂-C₁₀)heterocycloalkyl, aziridin-1-yl, oxetan-2-yl, tetrahydrofuran-3-yl, pyrrolidin-1-yl, tetrahydrothiophen-S,S-dioxide-2-yl, morpholin-4-yl 1,4-dioxan-2-yl, hexahydroazepin-4-yl, 3-oxa-cyclooctyl, 5-thio-cyclononyl, and 2-aza-cyclodecyl.

The term “halogen atom” or “halogen” means the radical of a fluorine atom (F), chlorine atom (Cl), bromine atom (Br), or iodine atom (I). The term “halide” means anionic form of the halogen atom: fluoride (F⁻), chloride (Cl⁻), bromide (Br⁻), or iodide (I⁻).

The term “saturated” means lacking carbon-carbon double bonds, carbon-carbon triple bonds, and (in heteroatom-containing groups) carbon-nitrogen, carbon-phosphorous, and carbon-silicon double bonds. Where a saturated chemical group is substituted by one or more substituents R^{S}, one or more double and/or triple bonds optionally may be present in substituents R^{S}. The term “unsaturated” means containing one or more carbon-carbon double bonds or carbon-carbon triple bonds, or (in heteroatom-containing groups) one or more carbon-nitrogen double bonds, carbon-phosphorous double bonds, or carbon-silicon double bonds, not including double bonds that may be present in substituents R^{S}, if any, or in aromatic rings or heteroaromatic rings, if any.

Reference will now be made in detail to embodiments of propylene polymerization processes. According to embodiments. propylene polymerization processes may include polymerizing propylene in the presence of a catalyst system to produce a propylene-based polymer. The catalyst system may include a metal-ligand complex according to formula (I):

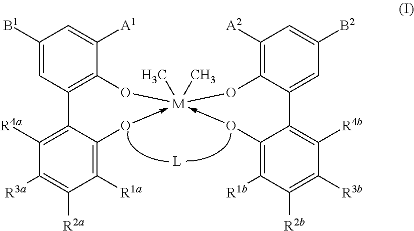

In formula (I), M is a metal chosen from zirconium or hafnium. The metal may have a formal oxidation state of +2, +3, or +4. In some embodiments. the metal has a formal oxidation state of +4. In some embodiments. M is zirconium. In some embodiments, M is hafnium.

The metal M in the metal-ligand complex of formula (I) may be derived from a metal precursor that is subsequently subjected to a single-step or multi-step synthesis to prepare the metal-ligand complex. Suitable metal precursors may be monomeric (one metal center), dimeric (two metal centers), or may have a plurality of metal centers greater than two, such as 3, 4, 5, or more than 5 metal centers. Specific examples of suitable hafnium and zirconium precursors, for example, include, but are not limited to HfCl₄, HfMe₄, Hf(CH₂Ph)₄, Hf(CH₂CMe₃)₄. Hf(CH₂SiMe₃)₄, Hf(CH₂Ph)₃Cl, Hf(CH₂CMe₃)₃Cl, Hf(CH₂SiMe₃)₃Cl, Hf(CH₂Ph)₂Cl₂, Hf(CH₂CMe₃)₂Cl₂, Hf(CH₂SiMe₃)₂Cl₂, Hf(NMe₂)₄, Hf(NEt₂)₄, and Hf(N(SiMe₃)₂)₂Cl₂; ZrCl₄, ZrMe₄, Zr(CH₂Ph)₄, Zr(CH₂CMe₃)₄, Zr(CH₂SiMe₃)₄, Zr(CH₂Ph)₃Cl, Zr(CH₂CMe₃)₃Cl, Zr(CH₂SiMe₃)₃Cl, Zr(CH₂Ph)₂Cl₂, Zr(CH₂CMe₃)₂Cl₂, Zr(CH₂SiMe₃)₂Cl₂, Zr(NMe₂)₄, Zr(NEt₂)₄, Zr(NMe₂)₂Cl₂, Zr(NEt₂)₂Cl₂, and Zr(N(SiMe₃)₂)₂Cl₂. Lewis base adducts of these examples are also suitable as metal precursors, for example, ethers, amines, thioethers, and phosphines are suitable as Lewis bases. Specific examples include HfCl₄(THF)₂, HfCl₄(SMe₂)₂ and Hf(CH₂Ph)₂Cl₂(OEt₂). Activated metal precursors may be ionic or zwitterionic compounds, such as (M(CH₂Ph)₃⁺)(B(C₆F₅)₄) or (M(CH₂Ph)₃⁺) (PhCH₂B(C₆F₅)₃) where M is Hf or Zr.

In formula (I), A¹ and A² are independently selected from the group consisting of radicals having formula (I-a) and radicals having formula (I-b):

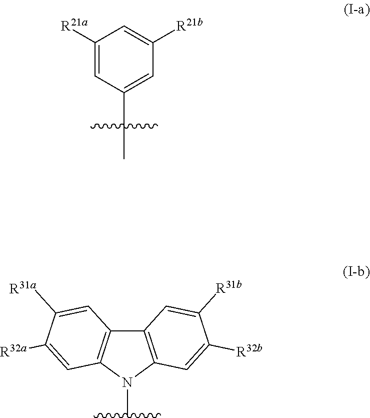

In formula (I-a), each of R^{21a} and R^{21b} is independently chosen from —H, (C₁-C₄₀)hydrocarbyl, (C₁-C₄₀)heterohydrocarbyl, —Si(R^{C})₃, —Ge(R^{C})₃, —P(R^{P})₂. —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O—)—, or halogen. In some embodiments, R^{21a} and R^{21b} are identical. In some embodiments, R^{21a} and R^{21b} are tert-butyl.

In formula (I-b), each of R^{31a}, R^{31b}, R^{32a}, and R^{32b} is independently chosen from —H, (C₁-C₄₀)hydrocarbyl, (C₁-C₄₀)heterohydrocarbyl, —Si(RC)₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{C})₂NC(O)—, or halogen. In some embodiments, R^{31a}, R^{31b}, R^{32a}, and R^{32b} are independently —H or (C₁-C₄₀)hydrocarbyl. In some embodiments, R^{31a}, R^{31b}, R^{32a}, and R^{32b} are independently —H or tert-butyl. In some embodiments, R^{31a} and R^{31b} are (C₁-C₄₀)hydrocarbyl and R^{32a} and R^{32b} are —H. In some embodiments, R^{32a} and R^{32b} are (C₁-C₄₀)hydrocarbyl and R^{31a} and R^{31b} are —H. In some embodiments. R^{31a} and R^{31b} are tert-butyl and R^{32a} and R^{32b} are —H. In some embodiments. R^{32a} and R^{32b} are tert-butyl and R^{31a} and R^{31b} are —H.

In some embodiments, both A¹ and A² are independently chosen radicals according to formula (I-a). In some embodiments, both A¹ and A² are independently chosen radicals according to formula (I-b). In some embodiments. A¹ and A² are identical. In some embodiments. A¹ and A² are radicals having formula (I-b), wherein R^{31a} and R^{31b} are (C₁-C₄₀)hydrocarbyl and R^{32a} and R^{32b} are —H. In some embodiments, A¹ and A² are radicals having formula (I-b), wherein R^{32a} and R^{32b} are (C₁-C₄₀)hydrocarbyl and R^{31a} and R^{31b} are —H. In some embodiments, A¹ and A2 are radicals having formula (I-b), wherein R^{31a} and R^{31b} are tert-butyl and R^{32a} and R^{32b} are —H. In some embodiments. A¹ and A² are radicals having formula (I-b), wherein R^{32a} and R^{32b} are tert-butyl and R^{31a} and R^{31b} are —H.

In formula (I), B¹ and B² are independently (C₁-C₄₀)hydrocarbyl. In example embodiments, B¹ and B² are independently methyl or tert-octyl. In some embodiments. B¹ and B² are identical. In example embodiments, both B¹ and B² are methyl. In example embodiments. both B¹ and B² are tert-octyl.

In formula (I), each of R^{1a}, R^{1b}, R^{2a}, R^{2b}, R^{3a}, R^{3b}, R^{4a}, and R^{4b} is independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen. In example embodiments, each of R^{1a}, R^{1b}, R^{2a}, R^{2b}, R^{3a}, R^{3b}, R^{4a}, and R^{4b} is independently selected from —H, (C₁-C₅)hydrocarbyl, —Si(R^{C})₃, and halogen. In example embodiments, each of R₁ₐ, R^{1b}, R^{2a}, R^{2b}, R^{3a}, R^{3b}, R^{4a}, and R^{4b} is independently selected from —H, (C₁-C₅)hydrocarbyl, chloro, and fluoro. In example embodiments, each of R^{1a}, R^{1b}, R^{2a}, R^{2b}, R^{3a}, R^{3b}, R^{4a}, and R^{4b} is independently selected from —H, (C₁-C₅)hydrocarbyl, —Si(R^{C})₃, chloro, and fluoro, provided that at least one of R^{1a}, R^{2a}, R^{3a}, and R^{4a} is not —H, and that at least one of R^{1b}, R^{2b}, R^{3b}, and R^{4b} is not —H. In example embodiments, each of R^{1a}, R^{1b}, R^{2a}, R^{2b}, R^{3a}, R^{3b}, R^{4a}, and R^{4b} is independently selected from —H, (C₁-C₅)hydrocarbyl, —Si(CH₃)₂(n-octyl), chloro, and fluoro. In example embodiments, each of R^{1a}, R^{1b}, R^{2a}, R^{2b}, R^{3a}, R^{3b}, R^{4a}, and R^{4b} is independently selected from —H, methyl, tert-butyl, chloro, and fluoro. In some embodiments, R^{1a} and R^{1b} are identical, R^{2a} and R^{2b} are identical, R^{3a} and R^{3b} are identical, and R^{4a} and R^{4b} are identical.

In formula (I), L is selected from the group consisting of —(CH₂)₂—, —(CH₂)₃—, —(CH₂)₄—, —(CH(CH₃)CH₂CH(CH₃))—, —(CH₂CH(R^{C})CH₂)—, —CH₂Si(R^{C})₂CH₂—, and —CH₂Ge(R^{C})₂CH₂—. In example embodiments, L is selected from the group consisting of —(CH₂)₂—, —(CH₂)₃—, —(CH₂)₄—, —(CH(CH₃)CH₂CH(CH₃))—, —(CH₂CH(R^{C})CH²)—, —CH₂Si(R^{C})₂CH₂—, and —CH₂Ge(R^{C})₂CH₂—, in which each R^{C} is (C₁-C₁₀)hydrocarbyl, in which each R^{C} is (C₁-C₅)hydrocarbyl, or in which each R^{C} is chosen from methyl, ethyl, propyl, iso-propyl, or tert-butyl. In further example embodiments, L is selected from the group consisting of —(CH₂)₂—, —(CH₂)₃—, and —(CH₂)₄—. In still further example embodiments, L is —(CH²CH(R^{C})CH²)—, where R^{C} is methyl or tert-butyl. In still further example embodiments, L is selected from the group consisting of —CH²Si(R^{C})²CH²— and —CH²Ge(R^{C})²CH²—, where each R^{C} is isopropyl. In a non-limiting specific embodiment, L is —CH²Ge(R^{C})²CH²—, where each R^{C} is isopropyl.

Except as otherwise defined, each R^{C}, R^{P}, and R^{N} in formula (I), including those R^{C}, R^{P}, and R^{N} that are part of formula (I) by virtue of being included in a radical of formula (I-a) or a radical of formula (I-b), is independently (C₁-C₃₀)hydrocarbyl, (C₁-C₃₀)heterohydrocarbyl, or —H.

In example non-limiting embodiments of propylene polymerization processes, the catalyst system includes a metal-ligand complex according to formula (I), as previously defined, in which A¹ and A² are radicals having formula (I-b), wherein R^{31a} and R^{31b} are (C₁-C40)hydrocarbyl and R^{32a} and R^{32b} are —H; or in which A¹ and A² are radicals having formula (I-b), wherein R^{32a} and R^{32b} are (C₁-C40)hydrocarbyl and R^{31a} and R^{31b} are —H.

In example non-limiting embodiments of propylene polymerization processes, the catalyst system includes a metal-ligand complex according to formula (I). as previously defined, in which B1 and B2 are tert-octyl.

In example non-limiting embodiments of propylene polymerization processes, the catalyst system includes a metal-ligand complex according to formula (I), as previously defined, in which R^{3a} and R^{3b} are fluoro. In further example embodiments, the catalyst system includes a metal-ligand complex according to formula (I), as previously defined, in which R^{3a} and R^{3b} are fluoro and each of R^{1a}, R^{1b}, R^{2a}, R^{2b}, R^{4a}, and R^{4b} is —H.

In example non-limiting embodiments of propylene polymerization processes, the catalyst system includes a metal-ligand complex according to formula (I), as previously defined. in which A¹ and A² are radicals having formula (I-b), where R^{31a} and R^{31b} are tert-butyl and R^{32a} and R^{32b} are —H; B¹ and B² are tert-octyl; and R^{1a}, R^{1b}, R^{2a}, R^{2b}, R^{3a}, R^{3b}, R^{4a}, and R^{4b} are independently selected from —H, methyl, tert-butyl, chloro, and fluoro.

In example non-limiting embodiments of propylene polymerization processes, the catalyst system includes a metal-ligand complex according to formula (I). as previously defined. in which M is hafnium; A¹ and A² are radicals having formula (I-b), where R^{31a} and R^{31b} are tert-butyl and R^{32a} and R^{32b} are —H; B¹ and B² are tert-octyl; and R^{1a}, R^{1b}, R^{2a}, R^{2b}, R^{3a}, R^{3b}, R^{4a}, and R^{4b} are independently selected from —H, methyl, tert-butyl, chloro, and fluoro.

In example non-limiting embodiments of propylene polymerization processes, the catalyst system includes a metal-ligand complex according to formula (I), as previously defined, in which M is hafnium; A¹ and A² are radicals having formula (I-b), where R^{31a} and R^{31b} are tert-butyl and R^{32a} and R^{32b} are —H; B¹ and B² are tert-octyl; R^{1a}, R^{1b}, R^{2a}, R^{2b}, R^{4a}, and R^{4b} are independently selected from —H, methyl, tert-butyl, chloro, and fluoro; and R^{3a} and R^{3b} are fluoro. In further specific non-limiting embodiments of propylene polymerization processes, the catalyst system includes a metal-ligand complex according to formula (I), as previously defined, where M is hafnium; A¹ and A² are radicals having formula (I-b), where R^{31a} and R^{31b} are tert-butyl and R^{32a} and R^{32b} are —H; B¹ and B² are tert-octyl; R^{1a}, R^{1b}, R^{2a}, R^{2b}, R^{4a}, and R^{4b} are —H; and R^{3a} and R^{3b} are fluoro. In further specific non-limiting embodiments of propylene polymerization processes, the catalyst system includes a metal-ligand complex according to formula (I), as previously defined, where M is hafnium; A¹ and A² are radicals having formula (I-b), where R^{31a} and R^{31b} are tert-butyl and R^{32a} and R^{32b} are —H; B¹ and B² are tert-octyl; R^{2a}, R^{2b}, R^{4a}, and R^{4b} are —H; R^{1a} and R^{1b} are methyl; and R^{3a} and R^{3b} are fluoro.

In one specific non-limiting embodiment of propylene polymerization processes, the catalyst system includes a metal-ligand complex according to formula (I), as previously defined, in which M is hafnium; A¹ and A² are radicals having formula (I-b), where each R^{31a} and R^{31b} are tert-butyl and each R^{32a} and R^{32b} are —H; B¹ and B² are tert-octyl; R^{1a}, R^{1b}, R^{2a}, R^{2b}, R^{4a}, and R^{4b} are —H; R^{3a} and R^{3b} are fluoro; and L is —CH₂Ge(R^{C})₂CH₂—, where each R^{C} is isopropyl.

### Procatalyst Activation

As previously described, in the propylene polymerization processes according to embodiments of this disclosure, the catalyst system includes a metal-ligand complex according to formula (I). The metal-ligand complex according to formula (I) may be in a catalytically active form or in a procatalyst form that is catalytically inactive or is at least substantially less catalytically active than the catalytically active form. Generally, the metal-ligand complexes according to formula (I) including two methyl groups bound to the metal M are catalytically inactive procatalyst forms of the metal-ligand complexes. A system including the metal-ligand complex of formula (I) in a procatalyst form may be rendered catalytically active by any technique known in the art for activating metal-based catalysts of propylene polymerization reactions. For example, a metal-ligand complex of formula (I) may be rendered catalytically active by contacting the metal-ligand complex to, or combining the metal-ligand complex with, an activating co-catalyst. Another example of a suitable activating technique includes bulk electrolysis. Combinations of one or more of the foregoing activating co-catalysts and techniques are also contemplated. Subjecting a metal-ligand complex according to formula (I) in a procatalyst form to any of such activating techniques results in a catalytically activated form of the metal-ligand complex according to formula (I). In some embodiments, the catalytically activated form of the metal-ligand complex according to formula (I) may be the result of cleaving at least one of the two methyl groups bound to the metal M in the procatalyst form of the metal-ligand complex according to formula (I) by any of the foregoing activation techniques.

### Co-catalyst Component

Optionally, the catalyst system in embodiments of propylene polymerization processes of this disclosure may further include an activating co-catalyst. Suitable activating co-catalysts include alkyl aluminums; polymeric or oligomeric alumoxanes (also known as aluminoxanes); neutral Lewis acids; and non-polymeric, non-coordinating. ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, modified methylalumoxanes (MMAO) such as triisobutylaluminum-modified methylalumoxane, and isobutylalumoxane.

Lewis acid activators (co-catalysts) include Group 13 metal compounds containing from 1 to 3 (C₁-C₂₀)hydrocarbyl substituents as described herein. In one embodiment, Group 13 metal compounds are tri((C₁-C₂₀)hydrocarbyl)-substituted-aluminum, tri((C₁-C₂₀)hydrocarbyl)-boron compounds. tri((C₁-C₁₀)alkyl)aluminum, tri((C₆-C₁₈)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating co-catalyst is a tetrakis((C₁-C₂₀)hydrocarbyl borate or a tri((C₁-C₂₀)hydrocarbyl)ammonium tetrakis((C₁-C₂₀)hydrocarbyl)borate (for example. bis(octadecyl)methylammonium tetrakis(pentafluorophenyl)borate). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbylN(H)₃⁺, or N(H)₄⁺, wherein each (C₁-C₂₀)hydrocarbyl, when two or more are present, may be the same or different.

Combinations of neutral Lewis acid activators (co-catalysts) include mixtures comprising a combination of a tri((C₁-C₄)alkyl)aluminum and a halogenated tri((C₆-C₁₈)aryl)boron compound, especially a tris(pentafluorophenyl)borane. Other embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex): (tris(pentafluoro-phenylborane):(alumoxane) [for example. (Group 4 metal-ligand complex):(tris(pentafluoro-phenylborane):(alumoxane)]are from 1:1:1 to 1:10:100, in other embodiments, from 1:1:1.5 to 1:5:30.

The catalyst system including the metal-ligand complex of formula (I) may be activated to form an active catalyst composition by combination with one or more co-catalysts, for example, a cation forming co-catalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to: modified methyl aluminoxane (MMAO), bis(hydrogenated tallow alkyl)methyl tetrakis(pentafluorophenyl)borate(1⁻) amine (i.c. [HNMe(C₁₈H₃₇)₂][B(C₆F₅)₄]), and combinations of both.

In some embodiments, one or more of the foregoing activating co-catalysts are used in combination with each other. An especially preferred combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. In some embodiments, the ratio is at least 1:5000, in some other embodiments, at least 1:1000; and 10:1 or less, and in some other embodiments. 1:1 or less. When an alumoxane alone is used as the activating co-catalyst, preferably the number of moles of the alumoxane that are employed is at least 100 times the number of moles of the metal-ligand complex of formula (I). When tris(pentafluorophenyl)borane alone is used as the activating co-catalyst. in other embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1. The remaining activating co-catalysts are generally employed in approximately mole quantities equal to the total mole quantities of one or more metal-ligand complexes of formula (I).

### Propylene and Optional α-Olefin

In the propylene polymerization processes according to embodiments of this disclosure, polymerizing the propylene in the presence of the catalyst system comprising the metal-ligand complex according to formula (I) produces a propylene-based polymer. The propylene polymerization processes according to embodiments of this disclosure include embodiments in which propylene is the only reactant and in which propylene is copolymerized with an additional reactant, such as an additional α-olefin. In embodiments in which propylene is the only reactant, the propylene-based polymer is a homopolymer of polypropylene. In embodiments in which an additional α-olefin is included with propylene, the propylene-based polymer is a copolymer of propylene and the additional α-olefin, which copolymer may include polypropylene blocks exhibiting isotacticity characteristics similar to those present in the polypropylene homopolymers that may be produced according to embodiments of this disclosure. Examples of additional α-olefin co-monomers typically have at least 2 carbon atoms and fewer than 20 carbon atoms. For example, the α-olefin co-monomers may have 2 to 10 carbon atoms, 2 to 8 carbon atoms, 3 to 10 carbon atoms, or 3 to 8 carbon atoms. Exemplary α-olefin co-monomers include, but are not limited to, ethylene, 1-butene, 1-pentene, 1-hexene, 1-heptene, 1-octene, 1-nonene, 1-decene, and 4-methyl-1-pentene. For example, the one or more α-olefin co-monomers may be selected from the group consisting of ethylene, 1-butene, 1-hexene, and 1-octene. In some embodiments, the additional α-olefin may comprise ethylene, and the propylene-based polymer comprises, based on the total weight of the propylene-based polymer, less than 50% by weight units derived from ethylene, less than 30% by weight units derived from ethylene, less than 25% by weight units derived from ethylene, less than 20% by weight units derived from ethylene, or less than 10% by weight units derived from ethylene. In some embodiments, the additional α-olefin co-monomer, if present, does not include ethylene, whereby the propylene-based polymer does not include monomer units derived from ethylene.

The propylene-based polymers, for example homopolymers and/or interpolymers (including copolymers) of propylene and optionally one or more co-monomers such as α-olefins. may include at least 50% by weight of units derived from propylene, based on the total weight of the propylene-based polymer. All individual values and subranges encompassed by “from at least 50% by weight” are disclosed herein as separate embodiments; for example, the ethylene based polymers, homopolymers and/or interpolymers (including copolymers) of propylene and optionally one or more co-monomers such as α-olefins may comprise, based on the total weight of the propylene-based polymer, at least 60% by weight of units derived from propylene; at least 70% by weight of units derived from propylene; at least 80% by weight of units derived from propylene; or from 50% to 100% by weight of units derived from propylene; from 80% to 100% by weight of units derived from propylene; from 90% to 100% by weight of units derived from propylene; from 95% to 100% by weight of units derived from propylene; from 99% to 100% by weight of units derived from propylene; from 99.9% to 100% by weight of units derived from propylene; or 100% by weight of units derived from propylene.

In some embodiments. the propylene-based polymers may comprise at least 50 mole percent units derived from propylene. All individual values and subranges from at least 90 mole percent are included herein and disclosed herein as separate embodiments. For example, the propylene based polymers may comprise at least 93 mole percent units derived from propylene; at least 96 mole percent units derived from propylene; at least 97 mole percent units derived from propylene; or in the alternative, from 90% to 100% by moles units derived from propylene; from 90% to 99.5% by moles of units derived from propylene; or from 97% to 99.5% by moles of units derived from propylene.

In some embodiments of the propylene based polymer, the amount of additional α-olefin, if present at all, is less than 50% by mole; other embodiments include at least 1 mole percent (mol %) to 20 mol %; and in further embodiments the amount of additional α-olefin includes at least 5 mol % to 10 mol %.

### Polymerization Process

In embodiments of propylene polymerization processes described herein, in which propylene is polymerized in the presence of the catalyst system including the metal-ligand complex according to formula (I), any otherwise conventional polymerization process may be employed to produce the propylene based polymers. Such conventional polymerization processes include, but are not limited to, solution polymerization processes, gas phase polymerization processes, slurry phase polymerization processes, and combinations thereof using one or more conventional reactors such as loop reactors, isothermal reactors, fluidized bed gas phase reactors. stirred tank reactors, batch reactors in parallel, series, or any combinations thereof, for example.

In some embodiments, polymerizing the propylene may be conducted via solution polymerization in a dual reactor system. for example a dual loop reactor system, wherein propylene and optionally one or more α-olefins are polymerized in the presence of the catalyst system, as described herein, and optionally one or more co-catalysts. In another embodiment. the propylene-based polymer may be produced via solution polymerization in a dual reactor system, for example a dual loop reactor system, wherein propylene and optionally one or more α-olefins are polymerized in the presence of the catalyst system in this disclosure, and as described herein, and optionally one or more other catalysts. The catalyst system, as described herein, may be incorporated in the first reactor, or second reactor, optionally in combination with one or more other catalysts. In one embodiment. the propylene-based polymer may be produced via solution polymerization in a dual reactor system, for example a dual loop reactor system, wherein propylene and optionally one or more α-olefins are polymerized in the presence of the catalyst system, as described herein, in both reactors. In another embodiment, the propylene-based polymer may be produced via solution polymerization in a single reactor system. for example a single loop reactor system, in which propylene and optionally one or more α-olefins are polymerized in the presence of the catalyst system, as described within this disclosure, and optionally one or more co-catalysts, as previously described.

In some embodiments, polymerizing the propylene may include polymerizing propylene and at least one additional -olefin in the presence of the catalyst system as previously described. In one or more embodiments, the catalyst system may include the metal-ligand complex according to formula (I) in its catalytically active form without a co-catalyst or an additional catalyst. In further embodiments, the catalyst system may include the metal-ligand complex according to formula (I) in its procatalyst form, its catalytically active form, or a combination of both forms, in combination with at least one co-catalyst. In further embodiments, the catalyst system may include the metal-ligand complex according to formula (I) in its procatalyst form in combination with at least one co-catalyst and at least one additional catalyst. In further embodiments, the catalyst system may include a first catalyst and at least one additional catalyst, and, optionally, at least one co-catalyst, where the first catalyst is a metal-ligand complex according to formula (I) in its catalytically active form.

In a polymerization process according to example embodiments. a reactor is charged with propylene and hydrogen at predetermined amounts and concentrations. The reactor is heated to a predetermined set temperature and charged with ethylene. An activated catalyst mixture is then injected into the reactor. The reactor temperature may be held constant by cooling the reactor as required. In adiabatic reactors, for example, heat of polymerization may be removed by injecting reactants at low temperature. In nonadiabatic reactors, for example, the heat of polymerization is removed by cold feed and/or heat transfer with a heat exchanger. At small scale, heat of polymerization may be removed through jacket cooling of a continuous stirred tank reactor (CSTR). After a predetermined time, the resulting hot solution may be transferred into a nitrogen-purged vessel, from which the propylene-based polymer is recovered following drying. For small-scale batch reactor systems, the reactor effluent may be transferred to a nitrogen-purged vessel and then manually transferred (with partial polymer-solvent separation) to a tray that is placed in an hot oven under vacuum to finish the devolatilization. For commercial-scale systems, the reactor effluent is processed through one or more devolatilization stages to vaporize and separate the solvent, unreacted propylene and/or unreacted additional alpha-olefin, and hydrogen from the propylene-based polymer.

In example embodiments of propylene polymerization processes, the propylene polymerization process is performed at a polymerization temperature of from 110° C. to 190° C. In further example embodiments of propylene polymerization processes, the propylene polymerization process is performed at a polymerization temperature of from 130° C. to 190° C. In still further example embodiments of propylene polymerization processes, the propylene polymerization process is performed at a polymerization temperature of greater than or equal to 160° C. In still further example embodiments of propylene polymerization processes, the propylene polymerization process is performed at a polymerization temperature of from 160° C. to 190° C.

### Optional Additives

In some embodiments, polymerizing the propylene optionally may include adding to the reaction one or more additives to produce a propylene-based polymer containing the one or more additives. Examples of additives include, but are not limited to, antistatic agents, color enhancers, dyes, lubricants, pigments, primary antioxidants, secondary antioxidants, processing aids, UV stabilizers, and combinations thereof. When additives are included in the polymerization process, the propylene-based polymers may contain any amount of such additives to be suited for a desired application. For example, if additives are included, the propylene-based polymers may include from greater than 0% to about 10% combined weight of such additives, based on the total weight of the propylene-based polymers including the one or more additives. The additive may further comprise fillers, which may include, but are not limited to, organic fillers or inorganic fillers. If such fillers are included, the propylene-based polymers may contain from greater than 0% to about 20 weight percent fillers such as, for example, calcium carbonate, talc, or Mg(OH)₂, based on the combined weight of the propylene-based polymers and all additives or fillers. The methods according to embodiments herein may further include blending the propylene-based polymers with one or more polymers to form a blend.

### Characteristics of Propylene-Based Polymers

In some embodiments, the propylene-based polymer resulting from the catalyst system that includes the metal-ligand complex of formula (I) has a polydispersity index (PDI) from 1 to 10, where PDI is defined as Mw/Mn with Mw being a weight-average molecular weight and Mn being a number-average molecular weight. In other embodiments, the propylene-based polymer may have a molecular weight distribution (MWD) from 1 to 6. In other embodiments. the propylene-based polymer may have a PDI from 1 to 3; and in other embodiments the propylene-based polymer may have a PDI from 1.5 to 2.5.

In embodiments. the propylene-based polymer resulting from the catalyst system that includes the metal-ligand complex of formula (I) is a polypropylene having greater than 90% isotactic triads or greater than 95% isotactic triads, as determined by carbon-13 NMR analysis. In some embodiments, the propylene-based polymer resulting from the catalyst system that includes the metal-ligand complex of formula (I) is a polypropylene having greater than 90% isotactic triads or greater than 95% isotactic triads, as determined by carbon-13 NMR analysis, when the polymerization is conducted at a reaction temperature of from 160° C. greater than 170° C. greater than 180° C., from 160° C. to 190° C., from 170° C. to 190° C., or from 160° C. to 190° C.

### EXAMPLES

The following examples are offered by way of illustration only and are not meant to be limiting.

Polypropylene samples were produced in a small-scale batch reactor by polymerizing predetermined amounts of propylene at various temperatures and pressures in the presence of a catalyst system including a metal-ligand complex according to Formula (I) as described. Catalyst efficiencies were determined in units of kilograms polymer per gram of metal M in the catalyst added to the reactor. The polypropylene samples were characterized to determine isotacticity (% mm). syndiotacticity (% rr), molecular weight (kilograms per mole), and polydispersity (PDI).

### Procatalysts

In the experiments described in these examples, the procatalysts tested either were obtained through a supplier or were synthesized according to known procedures such as those disclosed in one or more of United States Patent Application Publications: US 2020/0017611, US 2020/0109220, US 2020/0247917, US 2020/0270282, and US 2020/0277412. Catalyst performance and polymer characteristics of the various catalyst systems were compared against otherwise identical systems including Comparative Procatalyst 1, shown below, as the procatalyst metal-ligand complex.

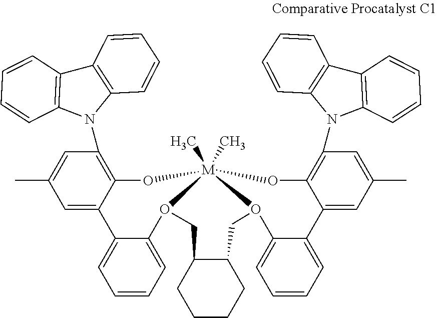

The procatalysts of the various systems tested had one of Formula (II), Formula (III), Formula (IV), or Formula (V), each of which is a subset of Formula (I) as previously described. The following table provides the structures for Formula (II), Formula (III), Formula (IV), or Formula (V), along with complete structural definitions for each of the procatalysts tested in these examples.

| | |
|---|---|
| | (Formula II) |
| 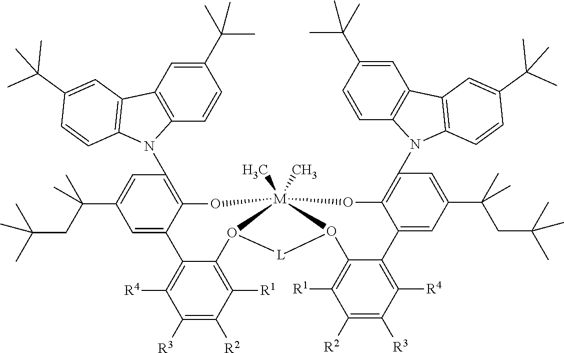 | |

| Formula (II) Procatalyst | M | R¹ | R² | R³ | R⁴ | L |
|---|---|---|---|---|---|---|
| Procatalyst 1 | Hf | —H | —F | —F | —H | —CH₂Ge(iPr)₂CH₂— |
| Procatalyst 2 | Hf | —H | —H | —F | —H | —(CH₂)₃— |
| Procatalyst 3 | Hf | —H | —H | —F | —H | —(CH₂)₄— |
| Procatalyst 4 | Hf | —H | —H | —Cl | —H | —(CH₂)₃— |
| Procatalyst 5 | Hf | —Me | —H | —Cl | —H | —(CH₂)₃— |
| Procatalyst 6 | Hf | —Me | —H | —F | —H | —(CH₂)₃— |
| Procatalyst 7 | Zr | —H | —H | —F | —H | —CH₂CH(CH₃)CH₂— |
| Procatalyst 8 | Hf | —H | —H | —F | —H | —CH₂CH(CH₃)CH₂— |
| Procatalyst 9 | Zr | —H | —H | —F | —H | —CH₂CH(tBu)CH₂— |
| Procatalyst 10 | Hf | —H | —H | —F | —H | —CH₂CH(tBu)CH₂— |
| Procatalyst 11 | Hf | —H | —H | —F | —H | —CH₂Si(iPr)₂CH₂— |
| Procatalyst 12 | Hf | —H | —H | —F | —H | —CH₂Si(iPr)₂CH₂— |
| Procatalyst 13 | Hf | —H | —H | —F | —H | —CH₂Ge(iPr)₂CH₂— |
| Procatalyst 14 | Hf | —H | —F | —F | —H | —CH₂Si(iPr)₂CH₂— |
| Procatalyst 15 | Hf | —H | —F | —F | —F | —(CH₂)₃— |
| Procatalyst 16 | Hf | —H | —H | —^{t}Bu | —H | —CH₂Si(CH₃)₂CH₂— |
| Procatalyst 17 | Hf | —Me | —H | —Cl | —H | —(CH₂)₂— |

| | |
|---|---|
| | (Formula III) |
| 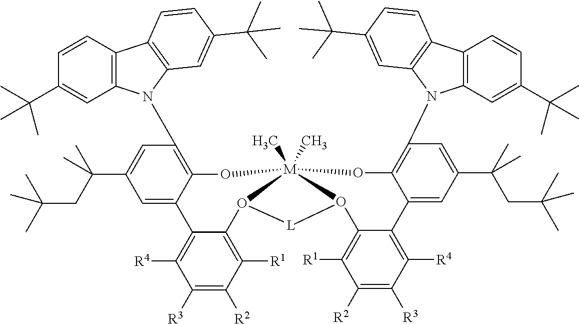 | |

| Formula (III) Procatalyst | M | R¹ | R² | R³ | R⁴ | L |
|---|---|---|---|---|---|---|
| Procatalyst 18 | Hf | —Me | —H | —F | —H | —(CH₂)₃— |
| Procatalyst 19 | Hf | —H | —H | —F | —H | —(CH₂)₃— |
| Procatalyst 20 | Zr | —Me | —H | —F | —H | —(CH₂)₃— |
| Procatalyst 21 | Hf | —Me | —H | —SiMe₂(n-Oct) | —H | —(CH₂)₃— |

| | |
|---|---|
| | (Formula IV) |
| 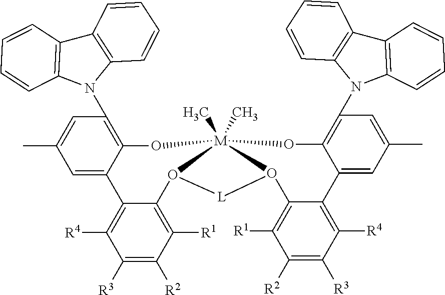 | |

| Formula (IV) Procatalyst | M | R¹ | R² | R³ | R⁴ | L |
|---|---|---|---|---|---|---|
| Procatalyst 22 | Hf | —H | —H | —H | —H | —(CH₂)₂— |
| Procatalyst 23 | Hf | —H | —H | —H | —H | 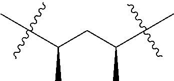 [SMILES: *[C@H](C)C[C@@H](*)C] |
| Procatalyst 24 | Hf | —H | —H | —H | —H | 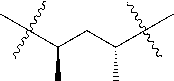 [SMILES: *[C@H](C)C[C@H](*)C] |

| | | | | | | (Formula V) |
|---|---|---|---|---|---|---|
| 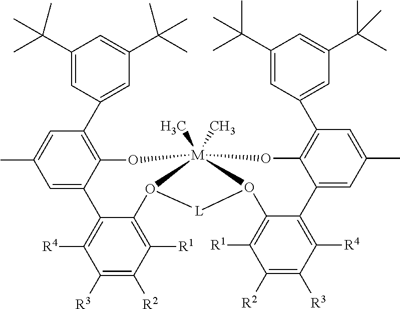 | | | | | | |
| Formula (V) Procatalyst | M | R¹ | R² | R³ | R⁴ | L |
| Procatalyst 25 | Zr | —H | —H | —^{t}Bu | —H | —(CH₂)₃— |
| Procatalyst 26 | Zr | —H | —F | —F | —F | —(CH₂)₃— |

A stirred, one-gallon autoclave reactor was charged with Isopar™-E (a synthetic isoparaffinic hydrocarbon fluid, available from ExxonMobil), propylene, and hydrogen at predetermined amounts and concentrations. The reactor then was heated to the set temperature and charged with ethylene. The amount of reagents and solvent were calculated for the initial reactor pressure to be 430 psig at the selected reactor temperature. The activated catalyst mixture was then injected into the reactor. The reactor temperature was maintained constant by cooling the reactor as required. After 10 minutes, the hot solution was transferred into a nitrogen-purged resin kettle. The copolymer was recovered following thorough drying in a vent hood and subsequent vacuum oven. The reactor was thoroughly rinsed with hot solvent between batches to remove trace amounts of copolymer from previous runs.

The tests were conducted according to one of the sets of reactor conditions A-K, as summarized in Table 1:

TABLE 1
Reactor conditions in the exemplary propylene polymerizations

| Reactor | Propylene | Isopar ™-E | Hydrogen | Pressure | Temperature | [C3] |
|---|---|---|---|---|---|---|
| Condition | (g) | (g) | (mmol) | (psig) | (° C.) | (g/L) |
| A | 605 | 944 | 10 | 234 | 70 | 148 |
| B | 189 | 1412 | 20 | 113 | 79 | 70 |
| C | 126 | 1580 | 0 | 118 | 100 | 44 |
| D | 455 | 1094 | 10 | 300 | 100 | 150 |
| E | 197 | 1425 | 20 | 154 | 109 | 56 |
| F | 568 | 987 | 10 | 418 | 110 | 177 |
| G | 605 | 1334 | 20 | 417 | 110 | 156 |
| H | 199 | 1411 | 20 | 190 | 129 | 53 |
| I | 316 | 1234 | 10 | 303 | 130 | 104 |
| J | 207 | 1323 | 20 | 263 | 160 | 52 |
| K | 211 | 1221 | 20 | 331 | 190 | 48 |

¹³C NMR Analysis

Samples for ¹³C NMR analysis were prepared by adding approximately 2.74 g of a 50/50 (v/v) mixture of tetrachloroethane-d2/o-dichlorobenzene containing 0.025 M Cr(acac)₃ to a 0.2-g polymer sample in a Norell 1001-7 10-mm NMR tube. Oxygen was removed by manually purging tubes with nitrogen for one minute. The samples were dissolved and homogenized by heating the tube and its contents to about 150° C. using a heating block with minimal use of heat gun. Each sample was visually inspected to ensure homogeneity. To ensure a representative, homogeneous sample, the samples were thoroughly mixed immediately prior to analysis and were not allowed to cool before insertion into the heated NMR probe.

The data were collected using a Bruker 400 MHz spectrometer. The data were acquired using 160 transients per data file and a 6 second pulse repetition delay with a sample temperature of 120° C. All measurements were made on non-spinning samples in locked mode. Samples were allowed to thermally equilibrate for 7 minutes prior to data acquisition. The ¹³C NMR chemical shifts were internally referenced to the mmmmm pentad at 21.9 ppm.

### DSC Analysis

The samples were submitted for Differential Scanning calorimetry (DSC). The “PP C-H” method was used with the following thermal sequence: Step 1: Place 5-10 mg of sample in a sample pan. Step 2: Equilibrate sample at 230.0° C. and maintain temperature for 5.0 minutes. Step 3: Ramp temperature of the sample at 10.0° C./min to −40.0° C. Step 4: Maintain temperature at −40.0° C. for 5.0 minutes. Step 5: Ramp temperature of the sample at 10.0° C./min to 230.0° C.

### GPC Analysis

The polymers were analyzed on a Polymer Char GPC IR high-temperature gel permeation chromatography (GPC) unit equipped with a high-sensitivity IR-5 detector. The oven temperature was set at 150° C. The solvent was nitrogen-purged 1,2,4-trichlorobenzene (TCB) containing about 200 ppm 2.6-di-t-butyl-4-methylphenol (BHT). The flow rate was 1.0 mL/min, and the injection volume was 200 μL. A 2.0 mg/mL sample concentration is prepared by dissolving the sample in nitrogen-purged and preheated TCB (containing 200 ppm BHT) for 30 minutes at 160° C. with gentle agitation.

The GPC column set was calibrated by running twenty narrow molecular-weight distribution polystyrene standards. The molecular weight (MW) of the standards ranges from 580 g/mol to 8,400,000 g/mol, and the standards were contained in six “cocktail” mixtures. A logarithmic molecular weight calibration was generated using a fourth-order polynomial fit as a function of elution volume. The equivalent polypropylene molecular weights were calculated by using following equation with reported Mark-Houwink coefficients for polypropylene.

### Data Analysis

Procatalyst efficiencies and propylene-based polymer characteristics collected as previously described and resulting from propylene polymerization reactions conducted according to one of the Batch Reactor Operation protocols A-K from Table 1 are presented in the following Table 2. Entries noted as “NS” are those from which data was not collected.

TABLE 2
Propylene-Based Polymer Characterizations

| | | Efficiency. | | | | | | | |
|---|---|---|---|---|---|---|---|---|---|
| | | (kilogram | | | | | | | |
| Reactor | | polymer per | Density. | | | Tm | Mw | Mn | |
| Conditions | Procatalyst | gram metal) | (g/cm³) | mm % | rr % | (° C.) | (kg/mol) | (kg/mol) | PDI |
| A | Comparative C1 | 1613 | NS | 97.0 | 0.7 | 142.6 | NS | NS | NS |
| A | Procatalyst 18 | 672 | NS | 12.6 | 52.8 | 143.9 | 114 | 44 | 2.6 |
| A | Procatalyst 20 | 2543 | NS | NS | NS | 143.3 | 43 | 17 | 2.5 |
| B | Procatalyst 18 | 476 | Amor. | 11.3 | 53.3 | Amor. | 213 | 79 | 2.7 |
| B | Procatalyst 21 | 586 | Amor. | 13.9 | 54.9 | Amor. | 91 | 37 | 2.5 |
| C | Comparative C1 | 215 | NS | NS | NS | 137.0 | 1073 | 377 | 2.8 |
| C | Procatalyst 2 | 560 | NS | NS | NS | 129.0 | 1083 | 500 | 2.2 |
| C | Procatalyst 3 | 303 | NS | NS | NS | 138.4 | 1410 | 616 | 2.3 |
| C | Procatalyst 4 | 401 | NS | NS | NS | 122.9 | 940 | 466 | 2.0 |
| D | Comparative C1 | 2480 | NS | 96.4 | 0.8 | 143.8 | 668 | 279 | 2.4 |
| D | Procatalyst 18 | 702 | NS | 18.9 | 47.7 | 143.7 | 361 | 160 | 2.3 |
| E | Comparative C1 | 511 | 0.900 | 96.6 | 1.0 | 143.1 | 135 | 64 | 2.1 |
| E | Procatalyst 1 | 7 | NS | NS | NS | 132.7 | 137 | 39 | 3.6 |
| E | Procatalyst 2 | 1596 | 0.901 | 95.0 | 1.4 | 133.8 | 161 | 79 | 2.0 |
| E | Procatalyst 10 | 1005 | 0.895 | 94.2 | 1.7 | 127.6 | 248 | 62 | 4.0 |
| E | Procatalyst 6 | 101 | 0.903 | 96.3 | 0.8 | 139.4 | 83 | 43 | 1.9 |
| E | Procatalyst 7 | 3648 | 0.888 | 92.2 | 2.5 | 110.1 | 28 | 13 | 2.1 |
| E | Procatalyst 8 | 5160 | 0.899 | 95.7 | 1.2 | 136.6 | 248 | 91 | 2.7 |
| E | Procatalyst 9 | 2178 | 0.879 | 88.1 | 4.4 | 82.6 | 59 | 14 | 4.3 |
| E | Procatalyst 12 | 17 | Amor. | 95.4 | 1.4 | 130.8 | 156 | 57 | 2.8 |
| E | Procatalyst 13 | 677 | 0.886 | 96.6 | 0.9 | 135.7 | 147 | 71 | 2.1 |
| E | Procatalyst 14 | 167 | 0.884 | 93.9 | 1.9 | 121.9 | 145 | 55 | 2.6 |
| E | Procatalyst 15 | 3 | NS | 84.3 | 5.6 | 101.6 | 136 | 49 | 2.8 |
| E | Procatalyst 18 | 271 | Amor. | 10.5 | 54.9 | Amor. | 67 | 32 | 2.1 |
| E | Procatalyst 21 | 504 | Amor. | 11.5 | 57.9 | Amor. | 44 | 18 | 2.4 |
| E | Procatalyst 26 | 121 | NS | 94.2 | 1.7 | 141.3 | 14 | 7 | 1.8 |
| F | Comparative C1 | 3111 | 0.899 | 95.2 | 0.9 | 144.0 | 324 | 135 | 2.4 |
| F | Procatalyst 2 | 1188 | 0.891 | 94.1 | 1.5 | 134.0 | 559 | 294 | 1.9 |
| F | Procatalyst 3 | 220 | 0.894 | 95.7 | 1.1 | 141.0 | 773 | 401 | 1.9 |
| F | Procatalyst 4 | 3126 | 0.881 | 92.7 | 1.9 | 130.0 | 510 | 274 | 1.9 |
| F | Procatalyst 6 | 1120 | NS | 96.1 | 0.7 | 139.9 | 155 | 76 | 2.0 |
| F | Procatalyst 17 | 90 | NS | 87.8 | 2.0 | 114.5 | 24 | 0.7 | 32.8 |
| F | Procatalyst 18 | 134 | NS | 11.0 | 52.6 | Amor. | 172 | 90 | 1.9 |
| F | Procatalyst 22 | 381 | NS | 92.7 | 1.3 | 133.0 | 3 | 2 | 1.5 |
| G | Comparative C1 | 1976 | NS | 96.5 | NA | 144.8 | 276 | 112 | 2.5 |
| G | Procatalyst 2 | 3686 | NS | 94.9 | NA | 136.7 | 355 | 164 | 2.2 |
| G | Procatalyst 3 | 997 | NS | 97.2 | NA | 144.2 | 336 | 155 | 2.2 |
| G | Procatalyst 5 | 2331 | NS | 95.7 | 0.8 | 136.0 | 107 | 52 | 2.1 |
| G | Procatalyst 16 | 524 | NS | 96.3 | NA | 127.3 | 162 | 75 | 2.2 |
| G | Procatalyst 23 | 288 | NS | 97.4 | NA | 155.0 | 198 | 94 | 2.1 |
| G | Procatalyst 24 | 562 | NS | 97.8 | NA | 154.6 | 187 | 79 | 2.4 |
| G | Procatalyst 25 | 146 | NS | 96.9 | 0.7 | 140.2 | 36 | 9 | 4.2 |
| H | Comparative C1 | 344 | 0.901 | 96.5 | 1.1 | 140.5 | 104 | 48 | 2.2 |
| H | Procatalyst 2 | 1340 | 0.900 | 95.0 | 1.4 | 134.8 | 162 | 83 | 2.0 |
| H | Procatalyst 6 | 80 | NS | 95.4 | 0.9 | 135.7 | 33 | 16 | 2.0 |
| H | Procatalyst 13 | 677 | 0.882 | 96.0 | 1.0 | 138.5 | 155 | 77 | 2.0 |
| I | Comparative C1 | 2151 | NS | 97.2 | 0.6 | 141.7 | NS | NS | NS |
| I | Procatalyst 18 | 1285 | NS | 19.1 | 47.3 | 144.6 | 94 | 37 | 2.5 |
| I | Procatalyst 19 | 1106 | NS | 26.2 | 35.6 | 146.0 | 130 | 52 | 2.5 |
| I | Procatalyst 20 | 1228 | NS | 10.8 | 58.1 | NS | NS | NS | NS |
| J | Comparative C1 | 93 | NS | 95.6 | 1.2 | 138.4 | 64 | 31 | 2.0 |
| J | Procatalyst 1 | 4 | NS | NS | NS | 138.6 | 87 | 28 | 3.1 |
| J | Procatalyst 2 | 493 | NS | 94.8 | 1.6 | 135.3 | 111 | 57 | 2.0 |
| J | Procatalyst 6 | 25 | NS | 93.6 | 1.5 | 132.0 | 9 | 4 | 2.0 |
| J | Procatalyst 7 | 1000 | 0.890 | 90.7 | 3.3 | 107.5 | 19 | 7 | 2.7 |
| J | Procatalyst 8 | 1188 | 0.893 | 83.5 | 7.3 | 133.3 | 57 | 12 | 4.9 |
| J | Procatalyst 9 | 0 | 0.893 | 86.9 | 4.7 | 130.4 | 23 | 10 | 2.3 |
| J | Procatalyst 10 | 532 | 0.896 | 92.9 | 2.1 | 138.1 | 98 | 40 | 2.4 |
| J | Procatalyst 11 | 31 | 0.902 | 96.4 | 0.9 | 138.3 | 99 | 42 | 2.3 |
| J | Procatalyst 13 | 471 | 0.902 | 96.7 | 0.8 | 140.4 | 113 | 58 | 2.0 |
| J | Procatalyst 14 | 295 | 0.900 | 95.4 | 1.2 | 134.3 | 87 | 36 | 2.4 |
| J | Procatalyst 26 | 17 | NS | NS | NS | 139.5 | 9 | 5 | 2.0 |
| K | Comparative C1 | 30 | NS | 93.7 | 1.7 | 133.4 | 31 | 12 | 2.6 |
| K | Procatalyst 2 | 101 | NS | 92.4 | 2.3 | 132.9 | 52 | 22 | 2.4 |
| K | Procatalyst 6 | 6 | NS | 89.7 | 3.1 | 127.9 | 17 | 2 | 8.3 |
| K | Procatalyst 13 | 79 | NS | 95.8 | 1.1 | 140.4 | 56 | 27 | 2.1 |

The ¹³C NMR analysis suggests that propylene concentration [C3] in the reactor had little effect on the tacticity of isotactic propylene-based polymers that were prepared. Notably, the % mm triads for Comparative C1 at propylene concentrations of 56 g/L and 156 g/L and for Procatalyst 2 at propylene concentrations of 56 g/L and 156 g/L were not different within experimental error. The Procatalyst 6 tacticity measurements did not change significantly from reaction conditions A (56 g/L [C3] with 20 mmol H₂) to reaction conditions F (177 g/L [C3] with 10 mmol H₂). Molecular weight effects on tacticity were not observed here. The hydrogen is not anticipated to affect the facial selectivity of the catalyst site for monomer. GPC analysis revealed a clear correlation of molecular weight with propylene concentration [C3] in the reactor, as anticipated, as the molecular weight increased with higher propylene concentration.

### Crystallinity/Composition

The Comparative CI procatalyst averaged 96.1% mm triads with a Tm of 144° C. The majority of the compounds examined as tabulated in Table 2 (17 out of 24 unique structures) had isotactic triad levels greater than 92.5% mm, ranging from 92.7% to 97.8% mm triads. The polymer melting points (Tm via DSC) of this set ranged from 122° C. to 155° C. and showed a general correlation between % mm triads and Tm. Only 2 of the 24 compounds, Procatalyst 18 and Procatalyst 21, were completely amorphous and showed no crystallinity via DSC.

Without intent to be bound by theory, the electronic character of the bottom phenyl ring in the procatalyst may have effected crystallinity, such that more electron withdrawing substituents resulted in a lower tacticity of the resulting propylene-based polymer. For example, when replacing para-fluoro substitution in Procatalyst 2 with para-chloro substitution in Procatalyst 4, isotacticity in the polypropylene was reduced by nearly 2% mm triads. This is reflected in a decrease of about 5° C. in the melting temperature Tm. This reduction was observed also for catalyst systems having multiple fluorinated bottom rings. Procatalyst 11 includes a simple para-fluoro substitution on its bottom ring. whereas Procatalyst 14 has 3,4-difluoro substitution and a 1.5% lower level of mm triads with a nearly 9° C. decrease in Tm. The germanium analogues, Procatalyst 13 and Procatalyst 1, respectively, also showed reductions in Tm, although less significant in magnitude (about 3° C.

The germanium bridge-based catalysts showed a propensity for increased crystallinity over the silicon based catalysts. For example. Procatalyst 13 yielded a resin with 1.2% mm triads and a Tm of 5° C. greater than that of Procatalyst 11. The 3,4-difluoro substituted catalysts also reflect this trend, as Procatalyst 1 exhibited a Tm that was 11° C. greater than that of Procatalyst 14. A similar result was observed for the analogous pair of Procatalyst 2 and Procatalyst 3, for which Procatalyst 3 showed higher crystallinity with a C4 bridge group L. versus a C3 bridge group L of Procatalyst 2.

Without intent to be bound by theory, it is believed that the substitution of ortho-methyl groups on the bottom phenyl rings of the procatalysts result in higher crystallinity propylene-based polymers, as observed in Procatalysts 2 and 6 and in Procatalysts 4 and 5. The % mm triad levels were 1.5% and 3% higher, respectively. for the ortho-methyl catalyst versus the parent compound. The Tm values were 5° C. and 6° C. higher, respectively. Procatalyst 6 produced one of the most highly isotactic samples at a reaction temperature of 109° C., with 96.2% mm triads.

Procatalysts 23 and 24 produced notably high crystallinity polypropylene with 97.4 and 97.8% mm, respectively, at a reaction temperature of 110° C. The Tm for the polymers produced by both catalysts was about 155° C. A notable feature of these catalysts is the bridge group L being 1.3-dimethylpropyl. in either the meso-configuration (Procatalyst 23) or the rac-configuration (Procatalyst 24).

### Molecular Weight

Samples prepared at polymerization temperatures of 110° C. were submitted for GPC analysis. In general, hafnium-based catalysts with a 3 or 4 atom bridge group L provided polymers with high Mw, and similar zirconium-based catalysts provided lower Mw polymers. For example, Comparative Cl provided a Mw of 276 kg/mole, whereas Procatalyst 25 provided a polymer with Mw of 36 kg/mole.

Changes in the electronic nature of the procatalyst ligand appeared to have little impact on the ability of the procatalyst to produce high molecular-weight polymers. For example. Procatalysts 2 and 4 produced polymers with molecular weights Mw of 559 kg/mole and 510 kg/mol, respectively. Similarly, Procatalysts 11 and 14 both produced a polymer with Mw of 145 kg/mol. No effect was observed from exchanging germanium for silicon in the Procatalysts 11 and 14.

Procatalysts 8 and 10 produced very high molecular weight polymers with Mw of about 248 kg/mol at a reaction temperature of 110° C., compared to Comparative C1. which produced a polymer with Mw of only 135 kg/mol under the same conditions.

### High Reactor Temperature Isotacticity

A common feature of many known polypropylene catalysts is the negative impact of increasing reactor temperature on isotacticity. Therefore, further experiments conducted at about 130° C., at 160° C., and at 190° C.(Reactor Conditions I, J, and K of Table 2) illustrate the abilities of many procatalysts according to formula (I) of this disclosure to produce highly isotactic polypropylenes even at increased reaction temperatures.

Polymers produced from Comparative C1 procatalyst exhibited decreased by of 1% mm owing to increasing reaction temperature from 110° C. to 160° C. An additional 2% mm reduction was observed at 190° C., with a measured level of isotactic triads of 93.7% mm. Thus, the overall decrease in % mm for Comparative C1 with the temperature increase from 110° C. to 190° C. was from 96.6 to 93.7. In comparison, with the increase of reactor temperature from 110° C. to 160° C. with Procatalyst 2 and 13. the measured isotacticity did not change significantly. Increasing the temperature to 190° C. resulted in a 2.5% mm decrease in isotactic triads for Procatalyst 2 and 1% mm Procatalyst 13. Of the catalysts examined over the 110° C. to 190° C. temperature range, only Procatalyst 6 showed a marked response in the level of isotacticity, with a decrease of 2.7% mm from 110° C. to 160° C. and an additional 4% mm at 190° C.

Unless otherwise defined, all technical and scientific terms used herein have the same meaning as commonly understood by one of ordinary skill in the art to which the invention belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

1. A propylene polymerization process comprising:
polymerizing propylene and an optional additional α-olefin comonomer in the presence of a catalyst system to produce a propylene-based polymer comprising at least 80% by weight monomer units derived from propylene, based on the total weight of the propylene-based polymer, the catalyst system comprising a metal-ligand complex according to formula (I): 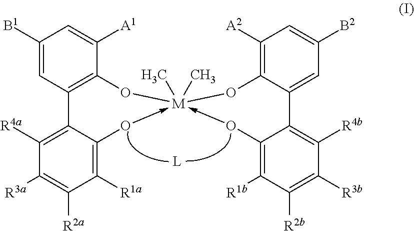
where:
M is zirconium or hafnium;
A¹ and A² are independently selected from the group consisting of radicals having formula (I-a) and radicals having formula (I-b): 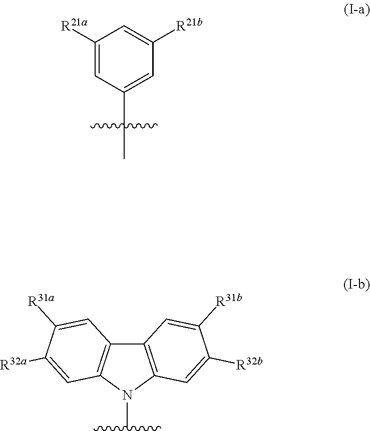
where each of R^{21a}, R^{21b}, R^{31a}, R^{31b}, R^{32a}, and R^{32b} is independently chosen from —H, (C₁-C₄₀)hydrocarbyl, (C₁-C40)heterohydrocarbyl, —Si(R^{C})₃, —Ge(R^{C})₃, −P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}(O)N(R^{N})—, (R^{C})₂NC(O)—, or halogen;
B¹ and B² are independently (C₁-C₄₀)hydrocarbyl;
R^{1a}, R^{1b}, R^{2a}, R^{2b}, R^{3a}, R^{3b}, R^{4a}, and R^{4b} are independently selected from —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂—OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R)—, (R^{C})₂NC(O)—, and halogen;
L is selected from the group consisting of —(CH₂)₂—, —(CH₂)₃—, —(CH₂)₄—,
—(CH(CH₃)CH₂CH(CH₃))—, —(CH₂CH(R^{C})CH₂)—,
—CH₂Si(R^{C})₂CH₂—, and —CH₂Ge(R^{C})₂CH₂—; and
each R^{C}, R^{P}, and R^{N} in formula (I) is independently (C₁-C₃₀)hydrocarbyl, (C₁-C₃₀)heterohydrocarbyl, or —H.

2. The propylene polymerization process of claim 1, wherein:
A¹ and A² are radicals having formula (I-b), wherein R^{31a} and R^{31b} are (C₁-C40)hydrocarbyl and R^{32a} and R^{32b} are —H; or A¹ and A² are radicals having formula (I-b), wherein R^{32a} and R^{32b} are (C₁-C40)hydrocarbyl and R^{31a} and R^{31b} are —H.

3. The propylene polymerization process of claim 1, wherein B¹ and B² are tert-octyl.

4. The propylene polymerization process of claim 1, wherein R^{3a} and R^{3b} are fluoro.

5. The propylene polymerization process of claim 1, wherein:
A¹ and A² are radicals having formula (I-b), where R^{31a} and R^{31b} are tert-butyl and R^{32a} and R^{32b} are —H;
B¹ and B² are tert-octyl; and
R^{1a}, R^{1b}, R^{2a}, R^{2b}, R^{3a}, R^{3b}, R^{4a}, and R^{4b} are independently selected from —H, methyl, tert-butyl, chloro, and fluoro.

6. The propylene polymerization process of claim 1, wherein:
M is hafnium;
A¹ and A² are radicals having formula (I-b), where R^{31a} and R^{31b} are tert-butyl and R^{32a} and R^{32b} are —H;
B¹ and B² are tert-octyl; and
R^{1a}, R^{1b}, R^{2a}, R^{2b}, R^{3a}, R^{3b}, R^{4a}, and R^{4b} are independently selected from —H, methyl, tert-butyl, chloro, and fluoro.

7. The propylene polymerization process of claim 6, wherein R^{3a} and R^{3b} are fluoro.

8. The propylene polymerization process of claim 7, wherein:
R^{1a} and R^{1b} are methyl; and
R^{2a}, R^{2b}, R^{4a}, and R^{4b} are —H.

9. The propylene polymerization process of claim 7, wherein R^{1a}, R^{1b}, R^{2a}, R^{2b}, R^{4a}, and R^{4b} are —H.

10. The propylene polymerization process of claim 1, wherein L is selected from the group consisting of —(CH₂)₂—, —(CH₂)₃—, and —(CH₂)₄—.

11. The propylene polymerization process of claim 1, wherein L is —(CH₂CH(R^{C})CH₂)—, where R^{C} is methyl or tert-butyl.

12. The propylene polymerization process of claim 1, wherein L is selected from the group consisting of —CH₂Si(R^{C})₂CH₂— and —CH₂Ge(R^{C})₂CH₂—.

13. The propylene polymerization process of claim 1, wherein L is selected from the group consisting of CH₂Si(R^{C})₂CH₂— and —CH₂Ge(R^{C})₂CH₂—, where each R^{C} is isopropyl.

14. The propylene polymerization process of claim 1, wherein L is —CH₂Ge(R^{C})₂CH₂—, where each R^{C} is isopropyl.

15. The propylene polymerization process of claim 1, wherein the polymerizing is performed at a polymerization temperature of from 110° C. to 190° C.

16. The propylene polymerization process of claim 1, wherein the polymerizing is performed at a polymerization temperature of from 130° C. to 190° C.

17. The propylene polymerization process of claim 1, wherein the polymerizing is performed at a polymerization temperature of greater than or equal to 160° C.

18. The propylene polymerization process of claim 1, wherein the polymerizing is performed at a polymerization temperature of from 160° C. to 190° C.

19. The propylene polymerization process of claim 1, wherein the propylene-based polymer is a polypropylene having greater than 90% isotactic triads.

20. The propylene polymerization process of claim 1, wherein the propylene-based polymer is a polypropylene having greater than 95% isotactic triads.
